(19) United States
(12) Patent Application Publication
(10) Pub. No.: US 2014/0373413 A1
(43) Pub. Date: Dec. 25, 2014

(54) Billboard with effective anti-reflection effect

(71) Applicant: Wei-Cheng Pan, Kaohsiung (TW)

(72) Inventor: Wei-Cheng Pan, Kaohsiung (TW)

(21) Appl. No.: 14/484,279

(22) Filed: Sep. 12, 2014

(30) Foreign Application Priority Data
Jan. 28, 2014 (TW) 103201796

(51) Int. Cl. G09F 15/00

(52) U.S. Cl. CPC G09F 15/0012; G09F 15/0068
USPC 40/768

(57) ABSTRACT

An improved structure of billboard is provided with a transparent layer, an image layer, and a base layer wherein a protective film is disposed on the image layer. The protective film, being through the high-temperature and pressurized process, makes the image layer to be attached to the bottom surface of the transparent layer. Next, the non-transparent and non-reflective base layer is placed on the bottom surface of the image layer to complete the assembly of the billboard. Therefore, just apply an adhesive layer on the bottom surface of the base layer and the billboard can be pasted on the wall or door panel. Owing to non-transparent and non-reflective characteristics, the base layer can effectively prevent shadows from appearing on the image layer to adversely affect the appearance of the image layer due to uneven paste on the adhesive layer or light irradiation on the adhesive layer.

### BACKGROUND OF THE INVENTION

1. Field of the Invention

The invention relates to billboards and more particularly to a billboard that has a non-transparent and non-reflective base layer, so that the visual effect of the image layer in the billboard will not be affected by the adhesive layer on the back of the billboard installed at any position.

2. Description of Related Art

In the busy main and small streets of the city, billboards can be seen in every corner. There are billboards using light-emitting diode (LED) display panels, or billboards pasted with adhesive layers on the back to be attached to the walls. Although billboards can achieve the effect of advertisement, however, billboards using LED display panels consume significant amount of electrical power. On the other hand, billboards that are adhered directly to the walls frequently suffer fading colors after a long period of time of being exposed to air and becoming oxidation.

Some billboards utilize transparent layers to wrap around in order to effectively resolve the oxidation that occurs when billboards have direct contact with air leading to problems of fading colors. However, since a transparent layer is also installed on the bottom surface of the billboard, when the adhesive layer is utilized to attach the billboard to the wall or door panel, it is easily to have shadows on the image layer due to uneven paste on the adhesive layer or light irradiation on the adhesive layer and affect the appearance of the image layer.

Thus, improvements still exist.

### SUMMARY OF THE INVENTION

It is therefore one object of the invention to provide an improved structure of billboard comprising a transparent layer; an image layer; and a base layer; wherein the transparent layer is the top layer of the billboard, and a protective film is on the top surface of the image layer and is adjoined to the transparent layer; wherein the protective film is attached to the transparent layer after being through the high-temperature and pressurized process; and wherein the base layer is disposed on the bottom surface of the image layer and is made of non-transparent and non-reflective colloid.

The above and other objects, features and advantages of the invention will become apparent from the following detailed description taken with the accompanying drawings.

### BRIEF DESCRIPTION OF THE DRAWINGS

FIG. 1 is a schematic diagram of the invention;

FIG. 2 is an exploded view of the invention;

FIG. 3 is a sectional view of the invention; and

FIG. 4 is a composite schematic diagram of a billboard.

### DETAILED DESCRIPTION OF THE INVENTION

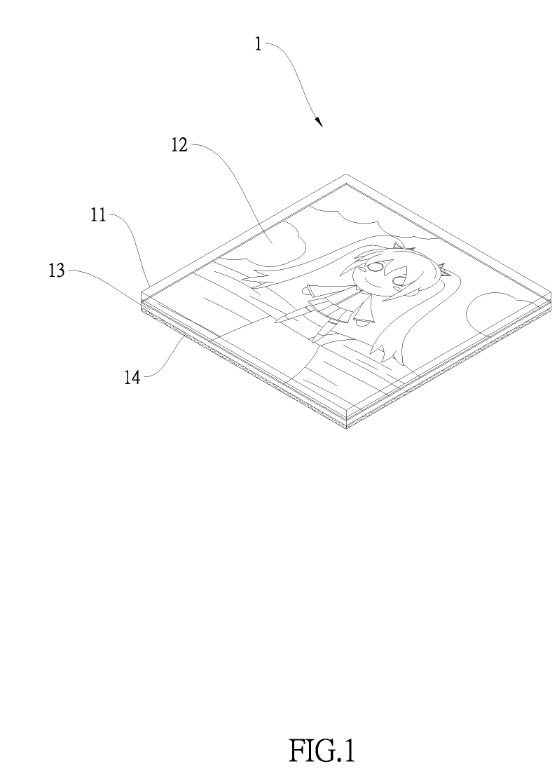

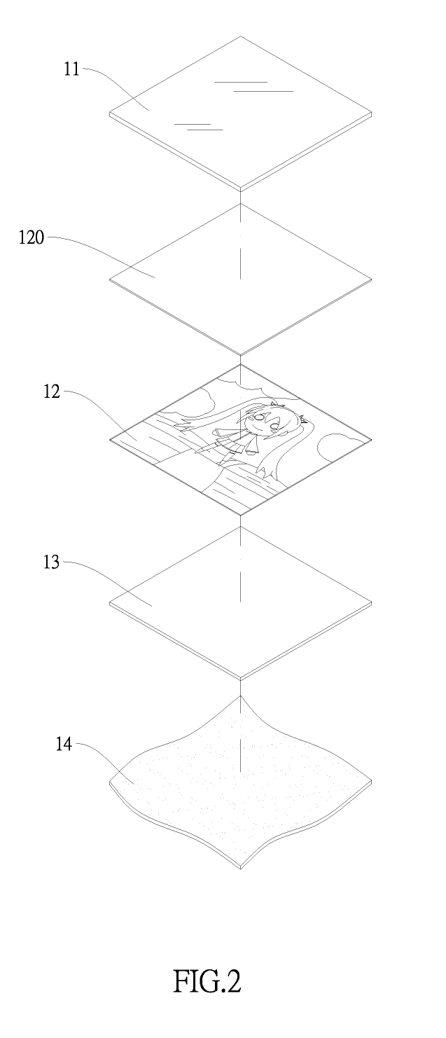

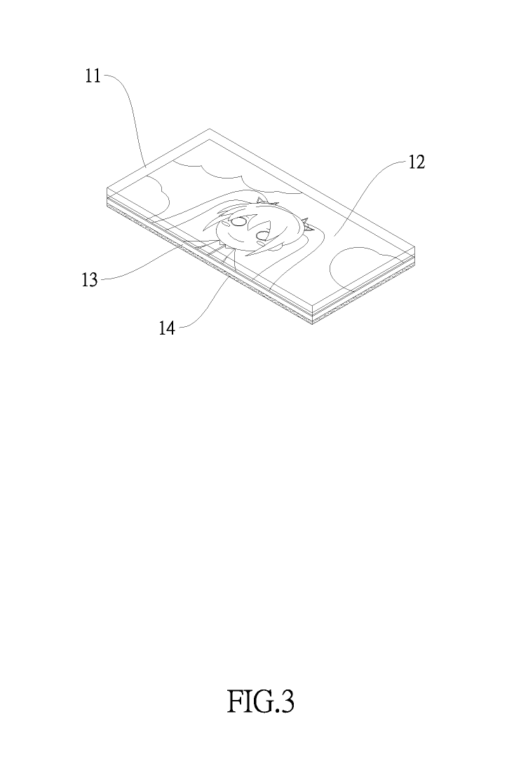

Referring to FIGS. 1 to 3, a billboard 1 in accordance with the invention comprises a transparent layer 11, an image layer 12 and a base layer 13. The transparent layer 11 can be a glass plate or an acrylic plate. A protective film 120 is placed on the top surface of the image layer 12 and the protective film 120 is heated at a temperature between 160-200 degrees Celsius and pressurized in order to attach the image layer 12 to the bottom surface of the transparent layer 11. Therefore, the image layer 12 is adhered to the bottom surface of the transparent layer 11. Next, a base layer 13 is provided on the bottom surface of the image layer 12. The base layer 13 is made of non-transparent and non-reflective polyvinyl chloride (PVC) colloid. Thus, a structure of billboard 1, which is water-proof, temperature resistance, and effectively preserves the beauty of the image layer 12, is completed.

When a user wants to place the billboard 1 on the wall, the user puts the adhesive layer 14 on the bottom surface of the base layer 13 and attaches the billboard 1 on the wall or the door panel by mean of the adhesive layer 14. Since the base layer 13 has non-transparent and non-reflective characteristics, if the adhesive layer 14 has uneven paste or the billboard 1 is in direct light irradiation, the adhesive layer 14 stored on the bottom surface of the base layer 13 will not create shadows due to light irradiation. The billboard has an effective anti-reflective effect without affecting the appearance of the image layer 12. In addition, since the image layer 12 is provided on the bottom surface of the transparent layer 11, the color of image layer 12 will not fade away or spall apart due to oxidation.

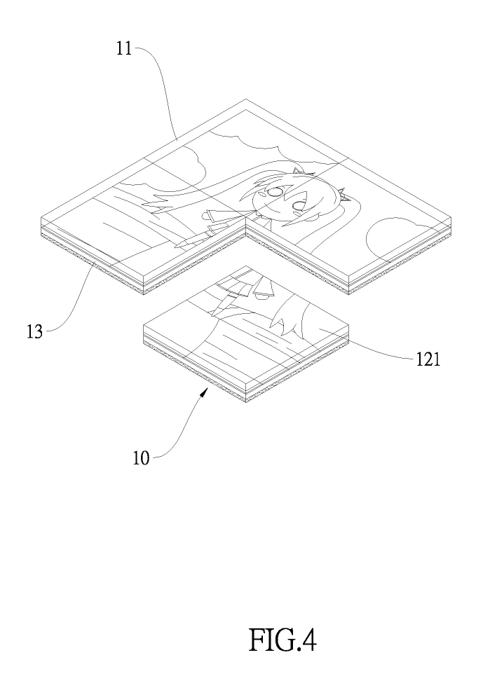

Referring to FIG. 4 in conjunction with FIG. 1, if the size of the image layer 12 is too big, the image layer 12 can be cut into a plurality of image blocks 121. Each image block 121 is combined with the transparent layer 11 and the base layer 13 to form a plurality of billboard blocks 10. Due to the division of the image, it is more convenient for production and transportation. Whenever display is needed, a plurality of billboard blocks 10 is assembled to form the billboard 1. Alternatively, the billboard 1 can be cut into a plurality of billboard blocks 10 for the convenience of transportation. Whenever display is needed, a plurality of billboard blocks 10 is assembled to form the billboard 1.

The invention has the following advantages:

1. Since the base layer has non-transparent and non-reflective characteristics, therefore, when a billboard is pasted to the wall using an adhesive layer, shadows will not appear on the image layer affecting the appearance due to uneven paste or direct light irradiation on the adhesive layer.

2. Since the image layer is attached to the bottom surface of the transparent layer and a base layer is attached to the bottom surface of the image layer, the setting can effective prevent the image layer from contacting air, colors of the image layer from fading away, or the image from spalling.

3. An image layer of the billboard has a transparent layer on the top surface and a base layer on the bottom surface so that the image layer of the billboard can be water-proof and temperature resistance.

While the invention has been described in terms of preferred embodiments, those skilled in the art will recognize that the invention can be practiced with modifications within the spirit and scope of the appended claims.

What is claimed is:

1. An improved structure of billboard comprising:
a transparent layer;
an image layer; and
a base layer;
wherein the transparent layer is the top layer of the billboard, and a protective film is on the top surface of the image layer and is adjoined to the transparent layer;
wherein the protective film is attached to the transparent layer after being through the high-temperature and pressurized process; and
wherein the base layer is disposed on the bottom surface of the image layer and is made of non-transparent and non-reflective colloid.

2. The improved structure of billboard as claimed in claim 1, wherein the transparent layer is a glass plate or an acrylic plate.

3. The improved structure of billboard as claimed in claim 1, wherein the high temperature is between 160-220 degrees Celsius.

4. The improved structure of billboard as claimed in claim 1, wherein the colloid is formed of PVC materials.

5. The improved structure of billboard as claimed in claim 1, wherein the image layer is cut into a plurality of image blocks so that each image block is combined with the transparent layer and the base layer to form a plurality of billboard blocks, and the billboard blocks are assembled into a billboard.

6. The improved structure of billboard as claimed in claim 1, wherein the billboard is cut into a plurality of billboard blocks for the convenience of transportation and reassembled into a billboard for display when needed.
